(19) United States
(12) Patent Application Publication
(10) Pub. No.: US 2025/0130046 A1
(43) Pub. Date: Apr. 24, 2025

(54) SYSTEM AND METHOD FOR AUTOMATED NAVIGATIONAL MARKER DETECTION

(71) Applicant: LOOKOUT, Inc., Brookline, MA (US)

(72) Inventors: BENJAMIN KIEFER, Brookline, MA (US); DAVID ROSE, Brookline, MA (US)

(73) Assignee: LOOKOUT, Inc., Brookline, MA (US)

(21) Appl. No.: 18/919,633

(22) Filed: Oct. 18, 2024

Related U.S. Application Data
(60) Provisional application No. 63/591,805, filed on Oct. 20, 2023.
(60) Provisional application No. 63/544,988, filed on Oct. 20, 2023.
(60) Provisional application No. 63/544,999, filed on Oct. 20, 2023.

(51) Int. Cl. G01C 21/20; B63B 51/00; G06F 16/29; G06V 10/82; G06V 20/56

(52) U.S. Cl. CPC G01C 21/203; B63B 51/00; G06F 16/29; G06V 10/82; G06V 20/56; G06V 2201/07

(57) ABSTRACT

A method for automated navigational marker detection and association in maritime applications includes providing a camera system equipped with one or more red-green-blue (RGB) cameras for capturing visual data of a surrounding maritime environment in real-time, and then providing a computing unit comprising a neural network-based object detector, a projection mechanism module, and a GPS mapping and chart data integration module. Next, providing a database comprising pre-existing chart data of navigational markers. Next, capturing visual data of the surrounding maritime environment using the camera system. Next, processing the visual data by the computing unit using the neural network-based object detector to identify navigational markers. Next, projecting pixel positions of detected navigational markers into a three-dimensional (3D) coordinate system. Next, integrating the projected positions of the detected navigational markers into a navigational map, and then cross-referencing the projected positions of the detected navigational markers with pre-existing chart data of navigational markers for the same location to enhance navigational accuracy and reliability.

### CROSS REFERENCE TO RELATED CO-PENDING APPLICATIONS

This application claims the benefit of U.S. provisional application Ser. No. 63/591,805 filed on Oct. 20, 2023 and entitled “System and method for automated navigational marker detection”, which is commonly assigned and the contents of which are expressly incorporated herein by reference.

This application claims the benefit of U.S. provisional application Ser. No. 63/544,988 filed on Oct. 20, 2023 and entitled “System and method for automated docking and safety monitoring for maritime vessels”, which is commonly assigned and the contents of which are expressly incorporated herein by reference.

This application claims the benefit of U.S. provisional application Ser. No. 63/544,999 filed on Oct. 20, 2023 and entitled “System and method for person-overboard detection and automated response”, which is commonly assigned and the contents of which are expressly incorporated herein by reference.

### FIELD OF THE INVENTION

The present invention relates to a system and a method for automated maritime navigation, and specifically to an automated maritime navigation system for detecting, identifying, and associating navigational markers in real-time to aid in maritime navigation for various types of vessels.

### BACKGROUND OF THE INVENTION

Navigational markers such as buoys, channel markers, and other maritime signage play a critical role in ensuring the safe and accurate navigation of vessels across water bodies. These markers provide essential information about water depths, hazards, channel boundaries, and other navigational instructions to mariners. Accurate detection, identification, and understanding of these markers are paramount to prevent navigational errors that could lead to severe maritime accidents.

Traditional methods of navigation often rely on the manual observation of navigational markers and interpretation of chart data by the mariners. However, this manual method is prone to human error, particularly in adverse weather conditions, poor visibility, or during nighttime when the visibility of navigational markers is severely compromised. Furthermore, conventional electronic navigation aids such as radar and sonar systems may not provide a clear or accurate representation of these navigational markers, especially in congested waterways.

Additionally, the existing automated navigational systems utilizing electronic chart data often lack real-time updating and verification against the actual positions of navigational markers. This discrepancy can lead to outdated or incorrect information being displayed, potentially resulting in navigational errors.

With the advancement in computer vision and machine learning technologies, there's an opportunity to develop an automated system that can accurately detect, identify, and associate navigational markers in real-time, thus enhancing the precision and reliability of maritime navigation. Such a system can significantly mitigate the risks associated with manual navigation and outdated electronic navigational aids.

Moreover, there is a growing need for a system that can seamlessly integrate the real-time visual data with existing chart data, providing a more accurate and visually enriched navigational map for mariners. This integration can further ensure that the navigational markers' positions on electronic maps are updated and verified in real-time, significantly enhancing maritime safety and navigation precision.

### SUMMARY OF THE INVENTION

The present invention relates to maritime navigation systems, and specifically to an automated system for detecting, identifying, and associating navigational markers in real-time to aid in maritime navigation for various types of vessels. The system is designed to function on a wide range of boats including but not limited to commercial vessels, fishing boats, recreational boats, and sailing yachts.

In general, in one aspect the invention provides a method for automated navigational marker detection and association in maritime applications. The method includes the following. First, providing a camera system equipped with one or more red-green-blue (RGB) cameras for capturing visual data of a surrounding maritime environment in real-time. Next, providing a computing unit comprising a neural network-based object detector, a projection mechanism module, and a GPS mapping and chart data integration module. Next, providing a database comprising pre-existing chart data of navigational markers. Next, capturing visual data of the surrounding maritime environment using the camera system. Next, processing the visual data by the computing unit using the neural network-based object detector to identify navigational markers. Next, projecting pixel positions of detected navigational markers into a three-dimensional (3D) coordinate system. Next, integrating the projected positions of the detected navigational markers into a navigational map, and then cross-referencing the projected positions of the detected navigational markers with pre-existing chart data of navigational markers for the same location to enhance navigational accuracy and reliability.

Implementations of this aspect of the invention include one or more of the following. The projection mechanism module uses an inertial measurement unit (IMU)-based orientation estimation techniques to facilitate the projection of pixel positions into the 3D coordinate system. The projection mechanism module uses a Computer Vision (CV)-based orientation estimation techniques to facilitate the projection of pixel positions into the 3D coordinate system. The method further includes using a local-greedy association strategy for aligning the detected navigational markers positions with the pre-existing chart data based on proximity. The method further includes using a global-optimal association strategy that utilizes an optimization algorithm to minimize the summed distances between the detected navigational markers positions and the pre-existing chart data for the navigational markers. The neural network-based object detector is trained to identify navigational markers based on characteristic shapes, colors, and patterns. The neural network-based object detector provides bounding boxes and confidence scores for each detected navigational marker. The neural network-based object detector further classifies the type of the detected navigational marker. The GPS mapping and chart data integration module updates a navigational map in real-time to reflect the positions of detected navigational markers, and enhances the visual representation of said navigational map based on the association with the pre-existing chart data.

In general, in another aspect the invention provides an automated navigational marker detection and association system for maritime applications, including a camera system equipped with one or more red-green-blue (RGB) cameras for capturing visual data of the surrounding maritime environment in real-time, and a computing unit comprising a neural network-based object detector, a database comprising chart data of navigational markers, a projection mechanism module, and a GPS mapping and chart data integration module. The neural network-based object detector is configured to process said visual data to identify navigational markers. The projection mechanism module is configured to project pixel positions of detected navigational markers into a three-dimensional (3D) coordinate system by extending rays from said pixel positions to a water surface thereby generating projected positions of detected navigational markers. The GPS mapping and chart data integration module is configured to integrate the projected positions of the detected navigational markers into a navigational map, and to cross-reference and compare said projected positions of the detected navigational markers with pre-existing chart data of navigational markers stored in the database for the same location.

Implementations of this aspect of the invention include one or more of the following. The projection mechanism uses an Inertial Measurement Unit (IMU)-based orientation estimation techniques to facilitate the projection of pixel positions into the 3D coordinate system. The projection mechanism uses a Computer Vision (CV)-based orientation estimation techniques to facilitate the projection of pixel positions into the 3D coordinate system. The system further includes a local-greedy association strategy for aligning the detected navigational markers positions with pre-existing chart data based on proximity. The system further includes a global-optimal association strategy that utilizes an optimization algorithm to minimize the summed distances between the detected navigational markers positions and pre-existing chart data for the navigational markers. The neural network-based object detector is trained to identify navigational markers based on characteristic shapes, colors, and patterns. The neural network-based object detector provides bounding boxes and confidence scores for each detected navigational marker. The neural network-based object detector further classifies the type of navigational marker. The GPS mapping and chart data integration module updates a navigational map in real-time to reflect the positions of detected navigational markers, and enhances the visual representation of said navigational map based on the association with pre-existing chart data. The system is configured to operate on commercial vessels, fishing boats, recreational boats, and sailing yachts.

The invention provides one or more of the following advantages. The invention leverages the synergy of augmented reality provided by RGB cameras, GPS technology, and machine learning, with computer vision algorithms to deliver an advanced navigational aid system that significantly enhances maritime safety and navigation precision, catering to a broad spectrum of vessels operating in diverse maritime conditions and navigational scenarios. The augmented reality overlays real-time information straight to the navigation helm and compares the information with stored data to generate an improved picture of the surrounding space. The advanced computer vision algorithms provide real-time alerts for navigation marker, approaching vessels, floating debris, person-overboard, automated docking and potential hazards, among others.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1A depicts an overview diagram of an automated maritime navigation system for detecting, identifying, and associating navigational markers in real-time, according to this invention;

FIG. 1B depicts an overview diagram of the computing unit of the automated maritime navigation system of FIG. 1A, including the modules for detecting, identifying, and associating navigational markers in real-time, according to this invention;

FIG. 1C and FIG. 1D depict an overview diagram of the computing platform architecture of the automated maritime navigation system of FIG. 1A;

FIG. 2A depicts a diagram illustrating the mounting of the red-green-blue (RGB) cameras on a boat;

FIG. 2B depicts a diagram illustrating the connection of the RGB cameras to the system of FIG. 1A;

FIG. 2C is a close-up image of another embodiment of a single RGB camera that includes different type of lenses;

FIG. 2D depicts the mounting mast for one of the cameras of FIG. 2A;

FIG. 2E depicts a cross sectional view of the mounting mast of FIG. 2D;

FIG. 2F is side view of a single panorama camera of the system of FIG. 1A;

FIG. 2G is a top view of the single panorama camera of FIG. 2F;

FIG. 2H depicts the fields of view of a single camera that includes different type of lenses;

FIG. 3A and FIG. 3B depict images showing the projection of pixel positions of navigation markers, other vessels and paths into the 3D world using the system of FIG. 1A;

FIG. 3C depicts an image showing the GPS map after integration of the detected navigational markers;

FIG. 4A and FIG. 4B depict a flow diagram for the process of detecting navigational markers according to this invention;

FIG. 5A depicts a flowchart illustrating the steps included in the local-greedy association process;

FIG. 5B depicts a flowchart illustrating the steps included in the global-optimal association process;

FIG. 6 depicts images showing various maritime applications of the system including intuitive navigation through congested waterways or in poor visibility conditions, night-vision, 360° degrees obstacle detection and docking assistance;

FIG. 7 depicts a screenshot of the user interface, showing how mariners can interact with the system to enhance navigation;

FIG. 8 depicts a flow diagram of the autodocking process;

FIG. 9 depicts a flowchart of the person-overboard and automated response process; and

FIG. 10 is a schematic diagram of an exemplary computer system 500 that is used to implement the system of the present invention.

### DETAILED DESCRIPTION OF THE INVENTION

The present invention relates to maritime navigation systems, and specifically to an automated system for detecting, identifying, and associating navigational markers in real-time to aid in maritime navigation for various types of vessels. The system is designed to function on a wide range of boats including but not limited to commercial vessels, fishing boats, recreational boats, and sailing yachts.

The invention aims to address the maritime navigation challenges by introducing an Automated Navigational Marker Detection and Association System that leverages RGB cameras, GPS technology, machine learning, and computer vision algorithms to provide an advanced real-time navigational aid for a wide range of vessels operating in diverse maritime conditions and navigational scenarios.

The core of the invention comprises a sophisticated camera system mounted on the boat, which employs RGB cameras to capture visual data from the surrounding maritime environment. The camera system is capable of real-time detection of navigational markers such as buoys, channel markers, and other significant maritime signage through the implementation of a neural network-based object detector.

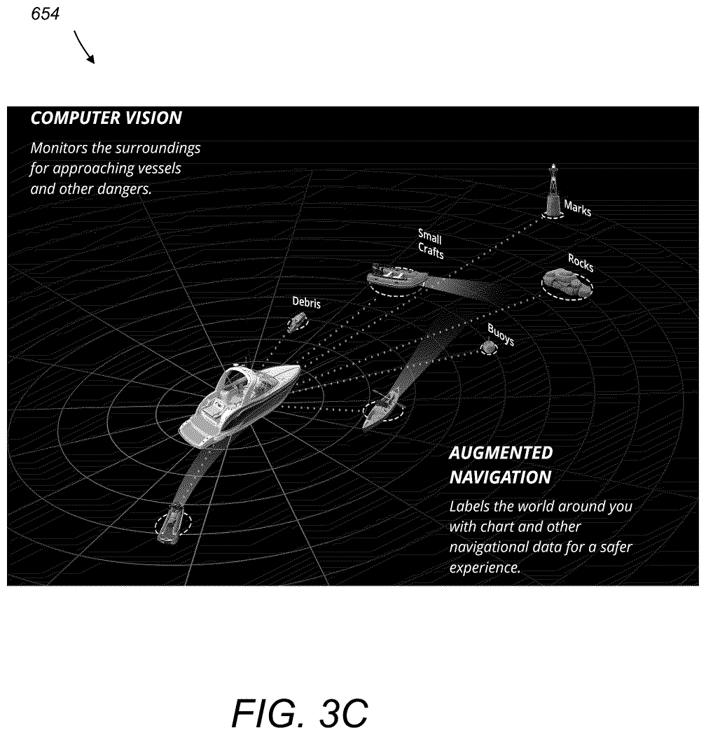

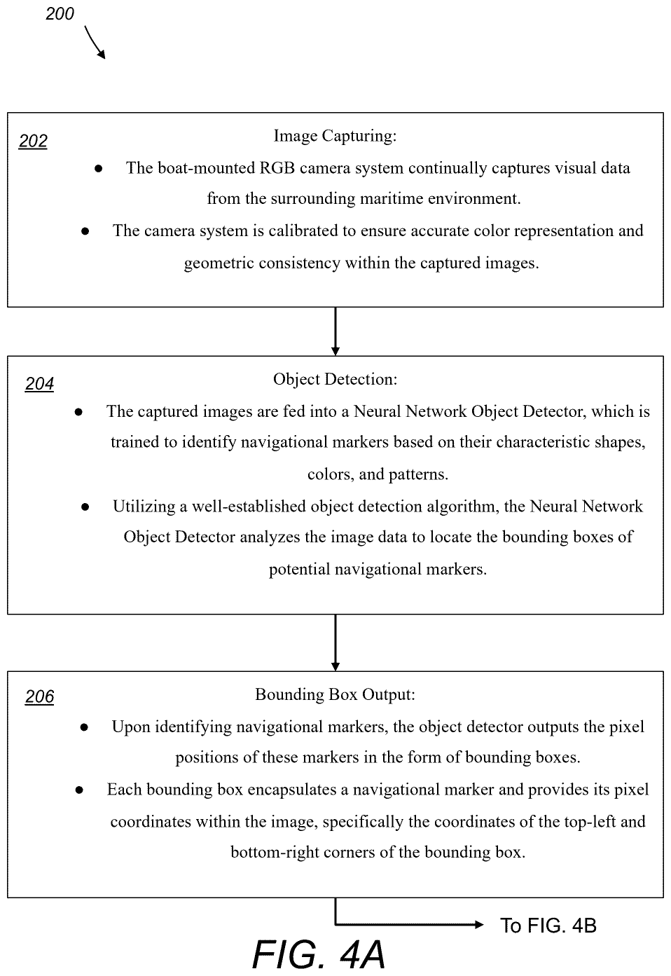

Further, the system utilizes a novel method of projecting the pixel positions of detected navigational markers 44, 45, 46 into the 3D world by extending the pixel positions along a ray until it intersects with the water surface, as shown in FIG. 3A and FIG. 3B. This projection can be performed using either an Inertial Measurement Unit (IMU) or Computer Vision (CV)-based orientation estimation techniques. Once projected, the positions of the computer vision-detected navigational markers 44, 45, 46 along with chevrons and safe passage tracks 55 indicating the correct passage direction and path are integrated into a GPS map for real-time monitoring and navigation assistance. Hazard alerts indicating shallow areas, and rocks are clearly marked to avoid collisions mishaps, as shown in FIG. 3C.

In addition, the system is designed to cross-reference the detected buoy positions with pre-existing chart data of buoys for the same location, enhancing the accuracy and reliability of the navigational aid. Through innovative local-greedy and global-optimal association strategies, the system optimizes the alignment of detected buoy positions with chart data, providing a more precise and visually enriched navigational map for mariners.

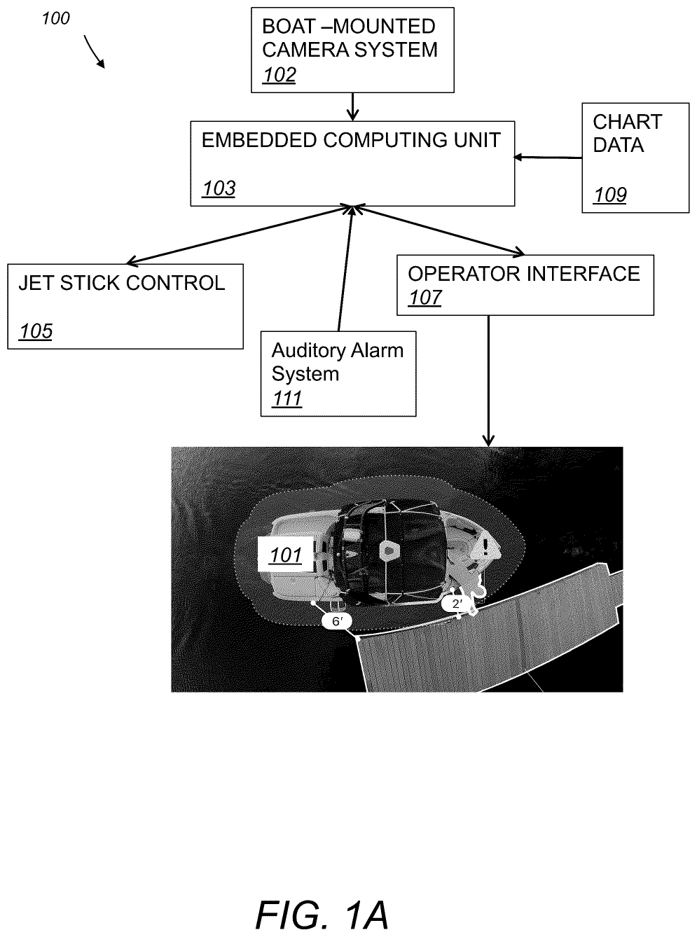

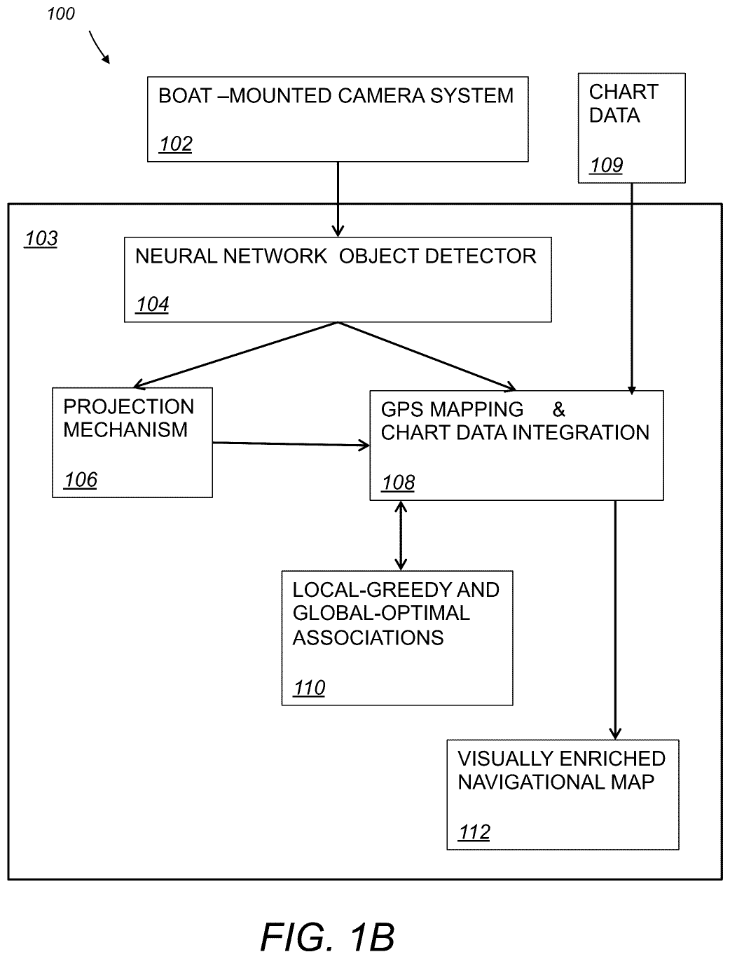

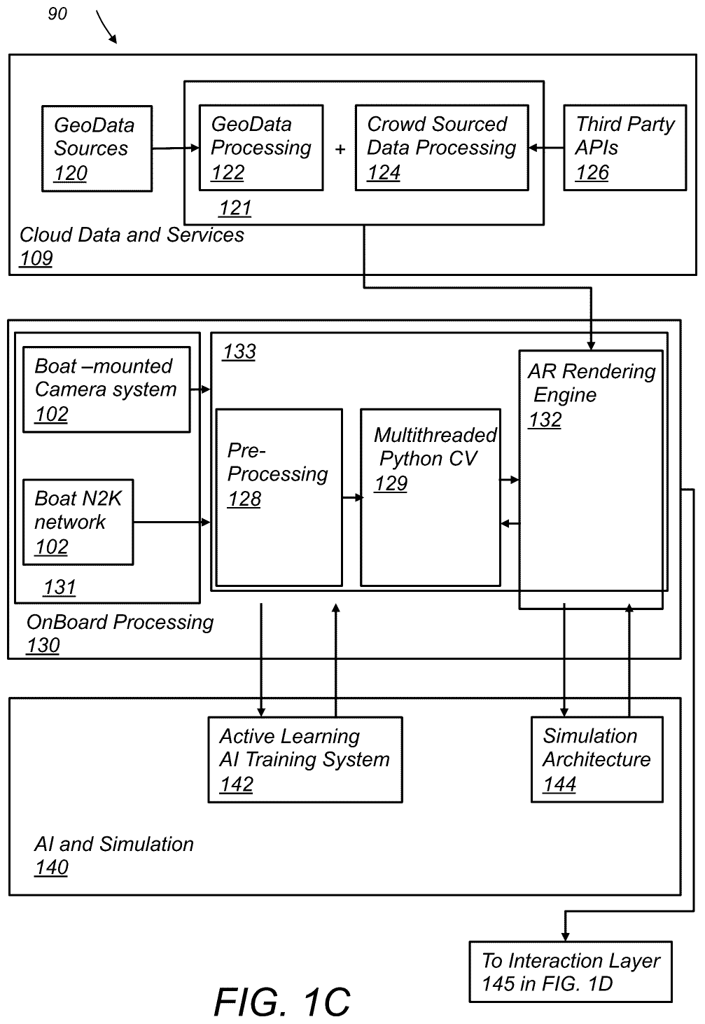

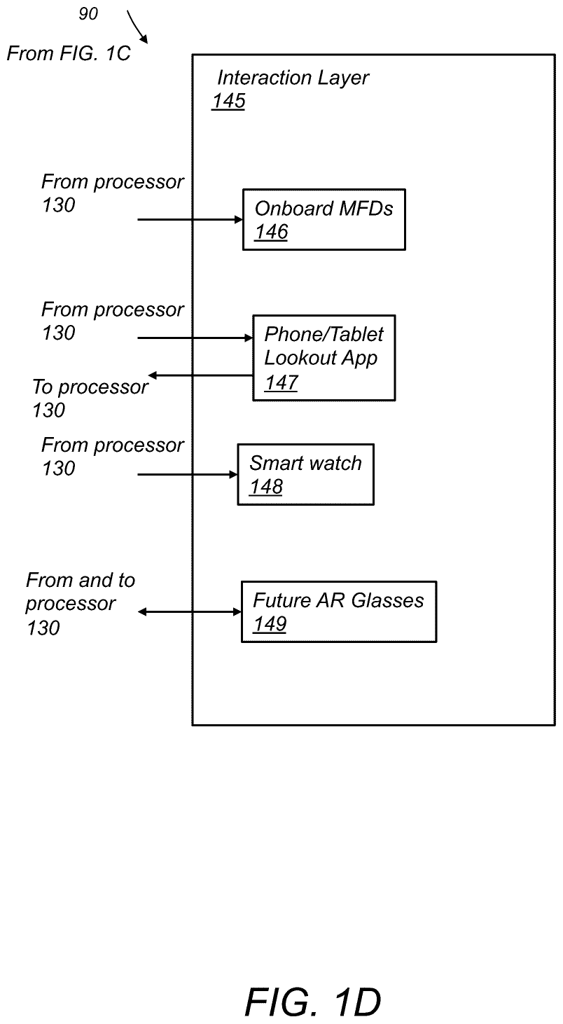

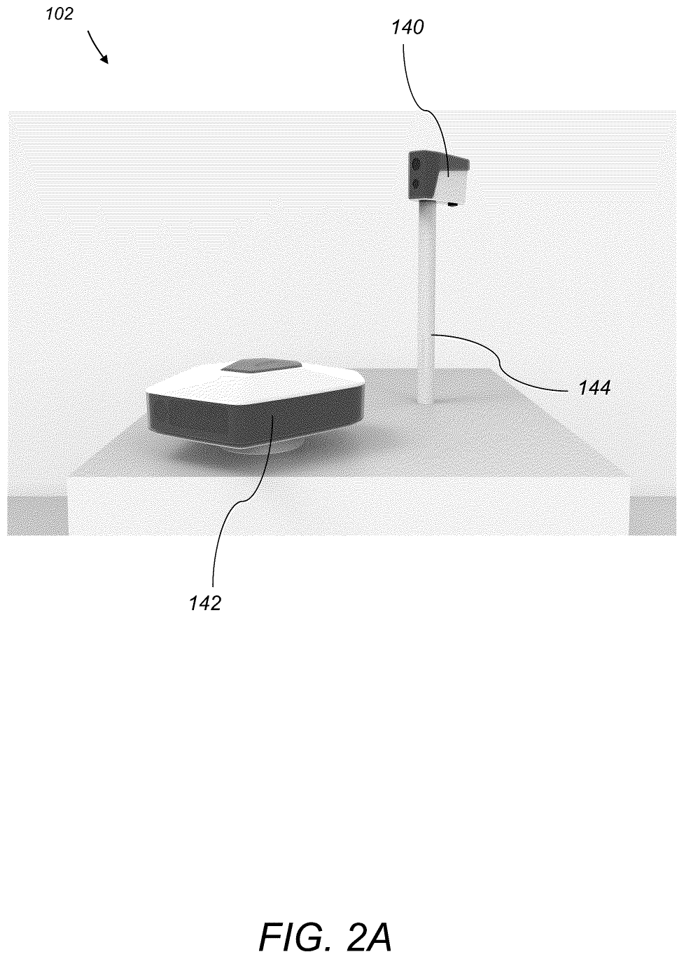

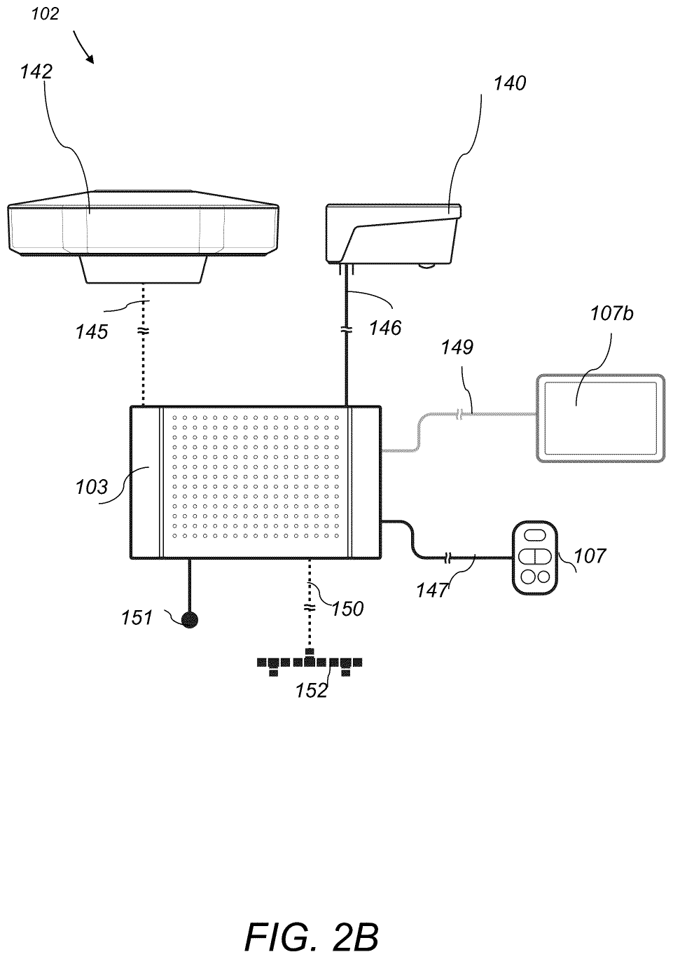

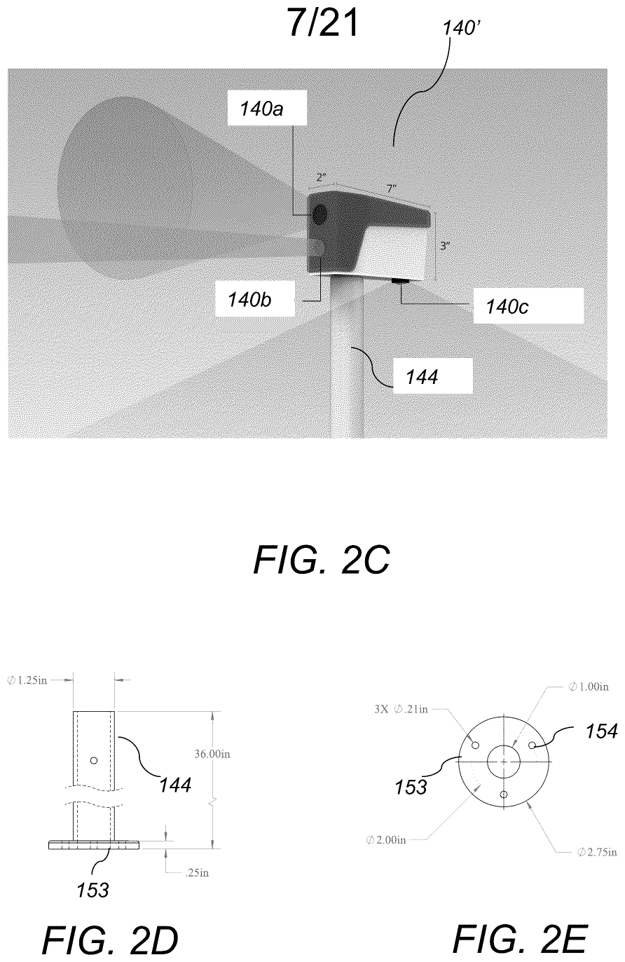

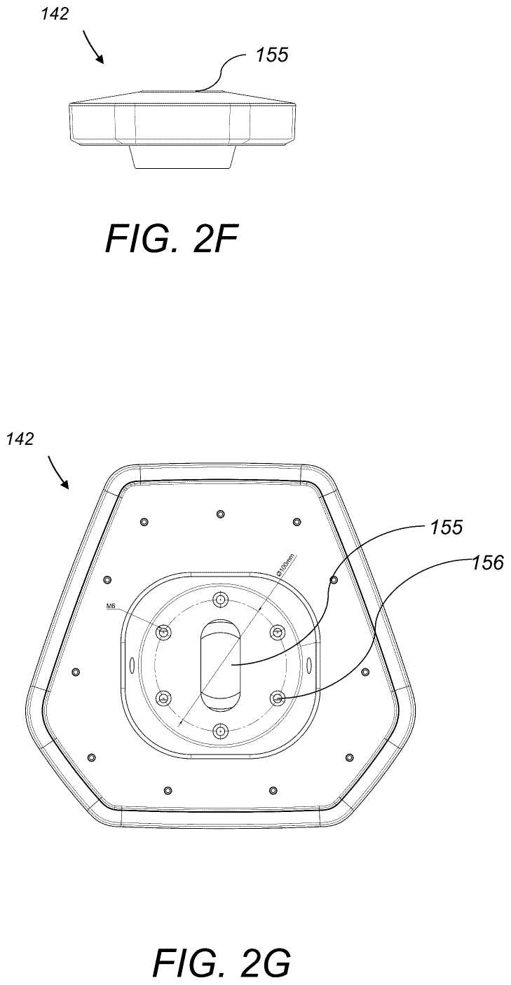

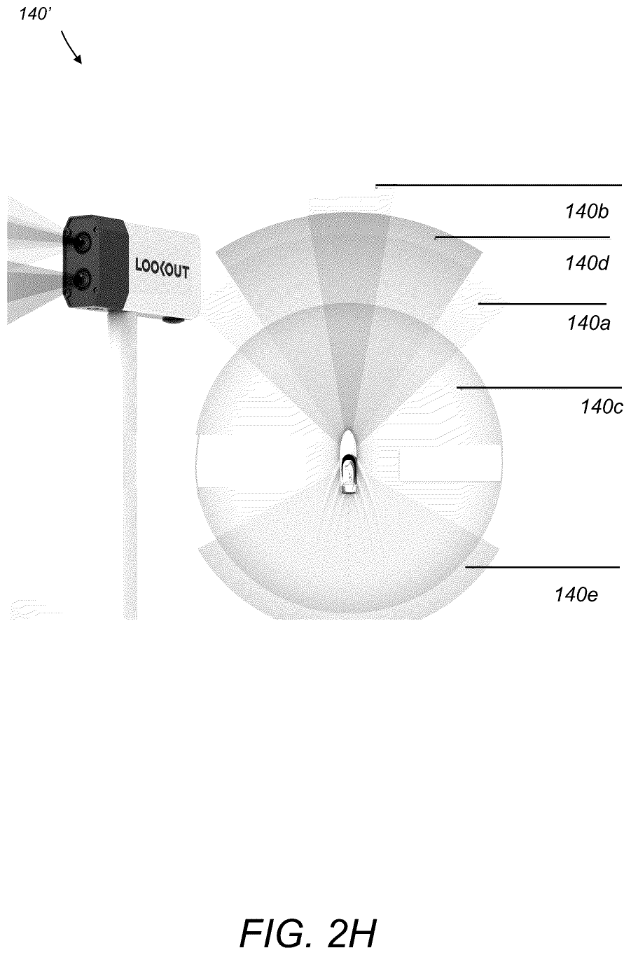

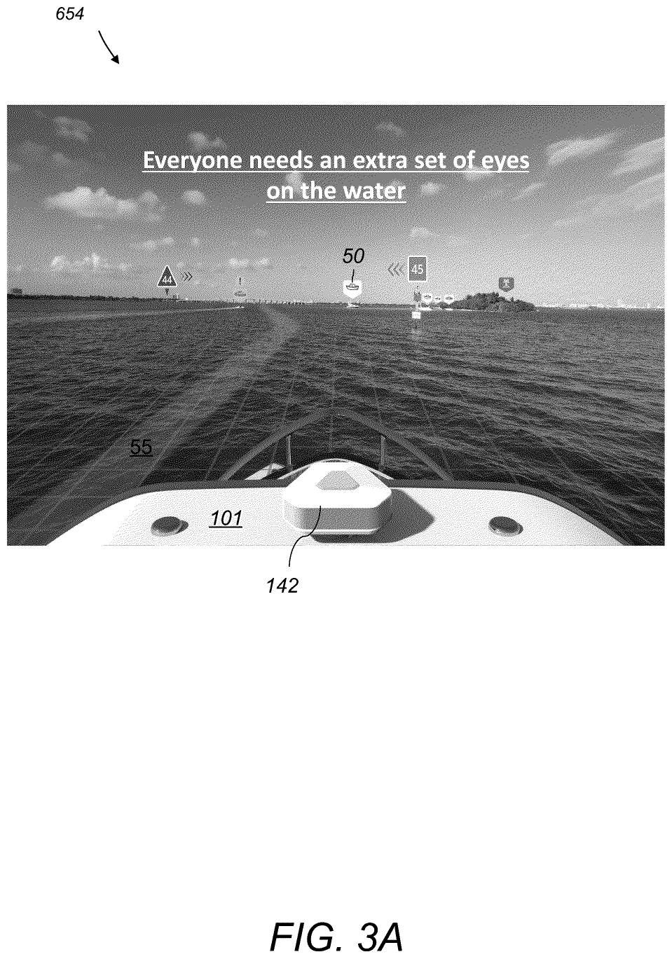

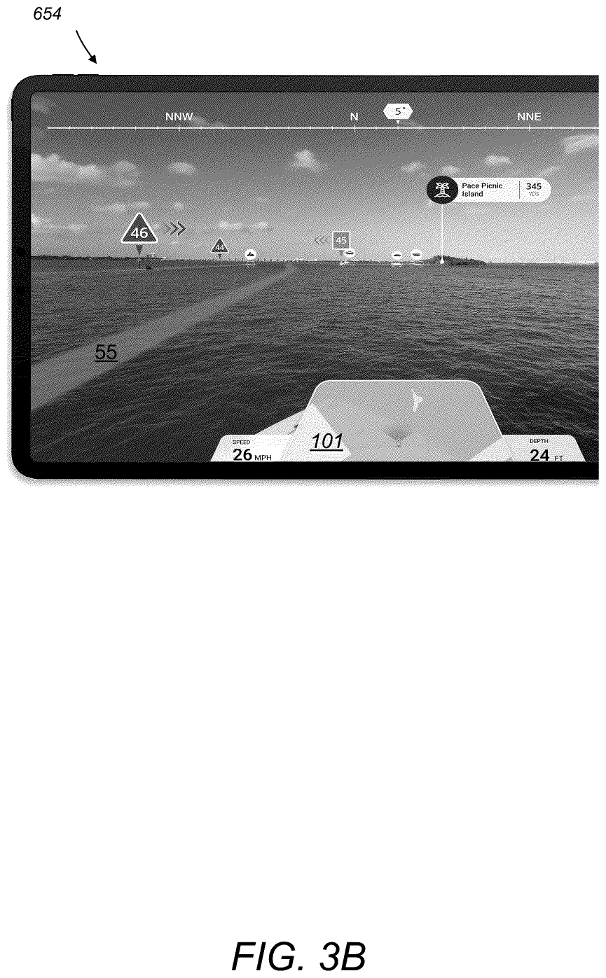

Referring to FIG. 1A, an automated system 100 for detecting, identifying, and associating navigational markers in real-time, includes a boat-mounted camera system 102, an embedded computing unit 103, a boat control unit 105 that engages the vessel's 101 propulsion and steering mechanisms, and an operator interface 107 that includes a user dashboard for real-time alerts and manual control, including auditory feedback mechanisms 110. In one example, the boat-mounted camera system 102 includes a high-resolution, elevated camera 140 providing a 360-degree surround field-of-view used for collision avoidance and docking, as shown in FIG. 2A. Boat-mounted camera system 102 also includes a panorama camera 142 used for night vision and augmented navigation, as will be described below, and shown in FIG. 2A. The system 100 also receives real time navigational chart data 109. Chart data 109 are stored in an onboard database or on a cloud-based database that is accessible via a network connection. The embedded computing unit 103 includes an onboard computer that processes image data captured by the boat-mounted camera system 102, and applies machine learning-based computer vision algorithms.

Referring to FIG. 1B, the embedded computing unit 103 includes a neural network object detector 104, a projection mechanism 106, global positioning system (GPS) mapping and chart data integration module 108, and local-greedy and global-optima association module 110. The boat-mounted camera system 102 is the core component of the system 100 that captures visual data of the maritime environment. The boat-mounted camera system 102 connects to the neural network object detector 104 and transfers the captured visual data. The neural network object detector 104 processes the visual data to identify navigational markers, and sends the data to the 3D projection mechanism 106 and GPS mapping and chart data integration module 108. The 3D projection mechanism 106 projects the detected navigational markers into the 3D world using an inertial measurement unit (IMU) or computer vision (CV)-based orientation estimation, and then feeds data to the GPS mapping and chart data integration module 108. The GPS mapping & chart data integration module 108 integrates the detected navigational marker data from the 3D projection mechanism 106 with the pre-existing data from the database 109 in real time and cross-references the detected buoy positions with the pre-existing chart data 109. The GPS mapping and chart data integration module 108 next applies local-greedy and global-optimal association strategies 110 to align the navigational marker/buoy positions, and then outputs a visually enriched navigational map 112. The local-greedy and global-optimal association strategies module 110 receives data from the GPS mapping and chart data integration module 106, optimizes alignment of the detected navigational marker/buoy positions with the chart data 109 and then feeds the optimized data back to GPS mapping and chart data integration module 108.

Referring to FIG. 1C, the computing platform architecture for the automated maritime navigation system of the present invention 90 includes a cloud data and services layer 109, an onboard processing pipeline 130 and an artificial intelligence (AI) simulation architecture 140. The cloud data and services layer 109 includes geolocation data 120, a data processing module 121 and third party application programming interfaces (APIs) 126. The data processing module 121 includes a geolocation data processing module 122 and a crowd sourced data processing module 124. The geolocation data processing module 122 processes the geolocation data 120 and the crowd sourced data processing module 124 processes data from the third party APIs 126. The data processing module 121 combines the processed data by the geolocation data processing module 122 and the crowd sourced data processing module 124 and sends them to an augmented reality (AR) rendering engine 132 in the onboard processing pipeline 130.

As was mentioned above, the pre-existing chart data database 109 includes real time data stored in the cloud and services that are accessed by the computing unit 103 via a network connection. In some embodiments, the pre-existing chart data database 109 are stored in a database on the computing unit 103. Examples of the cloud data and services include geolocation data provided by sources such as the Coast Guard, the National Oceanic and Atmospheric Administration (NOAA), the International Hydrographic Organization (IHO), and the National Geospatial-Intelligence Agency (NGA), among others. The geolocation data include marine charts, bathymetry data, weather tide and currents data, and wrecks and obstruction data, among others. Additional data and services are also provided by third party application programming interfaces (APIs) 126, such as Dock Wa (for slips and mooring reservations), Sirius XM Marine (for fishing mapping) DeepSea-Dave65 (for whale sightings), NOAA and IHO (for marine landmarks), Debris Tracker (for debris detection), Gas Buddy (for fuel dock location and gas pricing), Argo/ActiveCaptain (for community reports, routes and places), and automatic identification system (AIS) (for large vessel traffic data), among others.

The onboard processing pipeline 130 includes a sensor layer 131, a computing layer 133, and an interaction layer 145. The sensor layer 131 includes the boat-mounted camera system of the present invention 102 and marine sensors provided by the national marine electronics association (NMEA 2000) or (N2K) network 102. Examples of the camera system data include thermal video stream data, stereo video depth data, HD video stream data, 9-axis gyro, yaw, pitch, roll data, precision GPS data, and AIS data, among others. Example of the marine sensors include sonar (for bathymetry data), anemometer (for wind data), radar, current data and engine data, among others. The computing layer 133 includes a pre-processing module 128, a multithreaded Python™ computer vision (CV) module 129, and an augmented reality (AR) rendering engine 132. The pre-processing module 128 includes video stabilization, horizon locking, Kalman smoothing, and sensor fusion, among others. The multithreaded Python™ computer vision (CV) module 129 includes semantic segmentation, objection detection, tracking network, range estimation, heading and speed estimation, and anomaly detection, among others. The AR rendering engine 132 includes visualization behaviors, vision to chart position reconciliation, multimodal alert escalation algorithm, and 3D asset database. The AR rendering engine 132 receives real-time cloud chart data from the data processing module 121 and integrates them with the processed data from the computer vision (CV) module 129 and then outputs data to the interaction layer 145 for display. The interaction layer 145 includes onboard multi-function displays (MFDs) 146 that receive and display video data from the onboard processor 130, phones and tablets147 that operate a Lookout™ application and communicate with the onboard processor 130 via a wireless connection and send to the onboard processor 130 reports and user preferences, smart watches 148 that provides haptic alerts, and future augmented reality (AR) glasses 149 that capture and send six degrees of freedom (6-dof)-data to the onboard processor 130. The AI and simulation architecture 140 includes an active learning AI training system 142 and a simulation architecture 144. The active learning AI training system 142 includes video training examples, retraining neural network, and boundary cases used for iterative training. The active learning AI training system 142 receives data from the AI processing pipeline 133 and sends over-the-air data updates. The simulation architecture 144 includes 3D world-accurate scenarios with various boats for design and training, weather/fog/wave/wind generator and data collection systems to test designs, AR behaviors and feedback. The simulation architecture 144 receives user experience performance metrics and sends design improvements to the AR rendering engine 132.

Referring to FIG. 2A-FIG. 2B, the boat-mounted camera system 102 includes a camera 140 that provides a birdseye 360° surround view and a separate camera 142 that provides a panorama view. In another embodiment, system 102 includes a camera 140′ that incorporates both a birdseye 360° surround view camera and a panorama camera, as shown in FIG. 2C and FIG. 2H. In this embodiment, camera 140′ includes a wide high resolution lens 140a, a telephoto lens 140b, and a 360° surround view lens 140c, as shown in FIG. 2C. In other embodiments, camera 140′ further includes a night-vision camera 140d and a docking camera 140e, as shown in FIG. 2H. In one embodiment, camera 140′ is mounted on an elevated mast 144 and is used for collision avoidance, docking, digital image stabilization, and 360° surround view. In one example, elevated mast 144 is a hollow cylindrical tube that has an inner diameter of 1 inch and an adjustable height in the range of 1-3 feet and is mounted on a 2.75 inches diameter base 153, as shown in FIG. 2D and FIG. 2E. Base 153 is secured on a boat surface via three screws that are threaded through openings 15.

Panorama camera 142 is used for night vision and augmented navigation. Referring to FIG. 2F and FIG. 2G, camera 142 includes a night-vision sensor 155, and augmented navigation and digital image stabilization modules. Camera 142 mounts on a hard top surface with screws 156.

Referring to FIG. 2B, camera 142 is connected to the computing unit 103 via a USB-C cable 145 that is up to 30 feet long. Camera 140 is connected to the computing unit 103 via a CAT6 cable 146 that is up to 70 feet long. A tactile interface 107a is connected to the computing unit 103 via a USB-C cable that is up to 15 feet long and a multi-function display (MFD) or a tablet 107b is connected to the computing unit 103 wirelessly via WiFi or Bluetooth connection or via a digital video connection 149. Computing unit 103 is powered via 12V DC power supply 151 and is connected to a national marine electronics association (NMEA) 2000 network 152 via a USB-A cable 150 that is up to 15 feet long. In other embodiments, connections 145, 146, 147, 149, 150 are wireless network connections.

### Navigational Marker Detection

The process of detecting navigational markers is central to the functioning of the automated Navigational marker detection and association system of the present invention. The primary objective of this process is to accurately identify and locate navigational markers such as buoys, channel markers, and other significant maritime signage within the visual data captured by the boat-mounted RGB camera system.

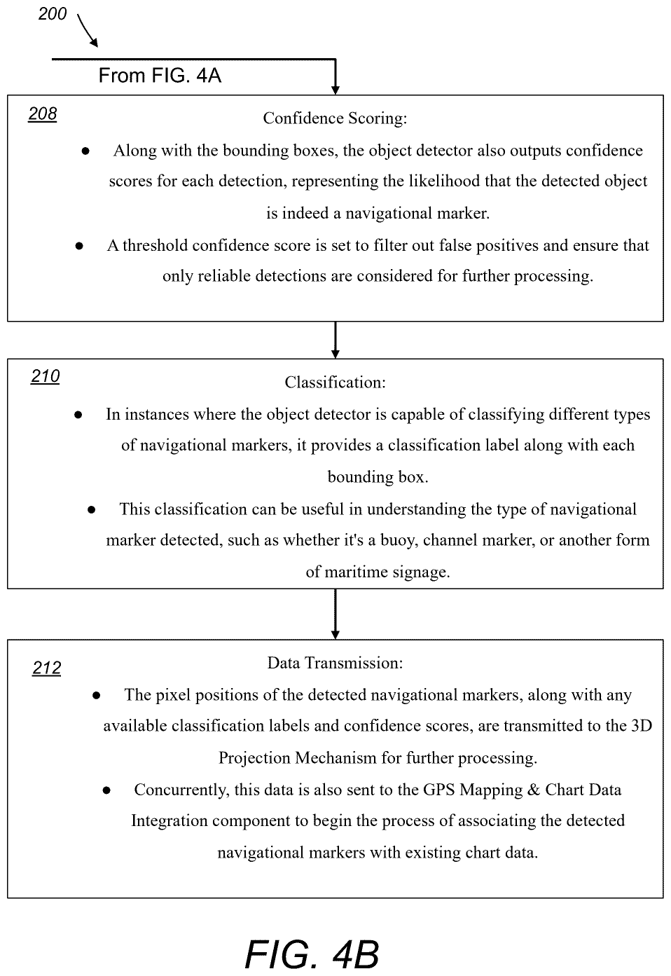

Referring to FIG. 4A and FIG. 4B, the navigational marker detection process 200 includes the steps of image capturing (202), object detection (204), bounding box output (206), confidence scoring (208), classification (210), and data transmission (212). In each step the following actions are taken:
Image Capturing (202):
   The boat-mounted RGB camera system continually captures visual data from the surrounding maritime environment.
   The camera system is calibrated to ensure accurate color representation and geometric consistency within the captured images.
Object Detection (204):
   The captured images are fed into a Neural Network Object Detector, which is trained to identify navigational markers based on their characteristic shapes, colors, and patterns.
   Utilizing a well-established object detection algorithm, the Neural Network Object Detector analyzes the image data to locate the bounding boxes of potential navigational markers.
Bounding Box Output (206):
   Upon identifying navigational markers, the object detector outputs the pixel positions of these markers in the form of bounding boxes.
   Each bounding box encapsulates a navigational marker and provides its pixel coordinates within the image, specifically the coordinates of the top-left and bottom-right corners of the bounding box.
Confidence Scoring (208):
   Along with the bounding boxes, the object detector also outputs confidence scores for each detection, representing the likelihood that the detected object is indeed a navigational marker.
   A threshold confidence score is set to filter out false positives and ensure that only reliable detections are considered for further processing.
Classification (210):
   In instances where the object detector is capable of classifying different types of navigational markers, it provides a classification label along with each bounding box.
   This classification can be useful in understanding the type of navigational marker detected, such as whether it's a buoy, channel marker, or another form of maritime signage.
Data Transmission (212):
   The pixel positions of the detected navigational markers, along with any available classification labels and confidence scores, are transmitted to the 3D Projection Mechanism for further processing.
   Concurrently, this data is also sent to the GPS Mapping & Chart Data Integration component to begin the process of associating the detected navigational markers with existing chart data.

Through the above described process 200, the system efficiently and accurately identifies navigational markers in real-time, enabling the subsequent steps of 3D projection and chart data integration to enhance maritime navigation significantly.

### Buoy Association Strategies

The effective association of detected buoy positions with existing chart data is pivotal in ensuring the accuracy and reliability of the navigational aid provided by the Automated Navigational Marker Detection and Association System. Two innovative strategies, namely Local-Greedy Association 300 and Global-Optimal Association 350, are employed to optimize this alignment.

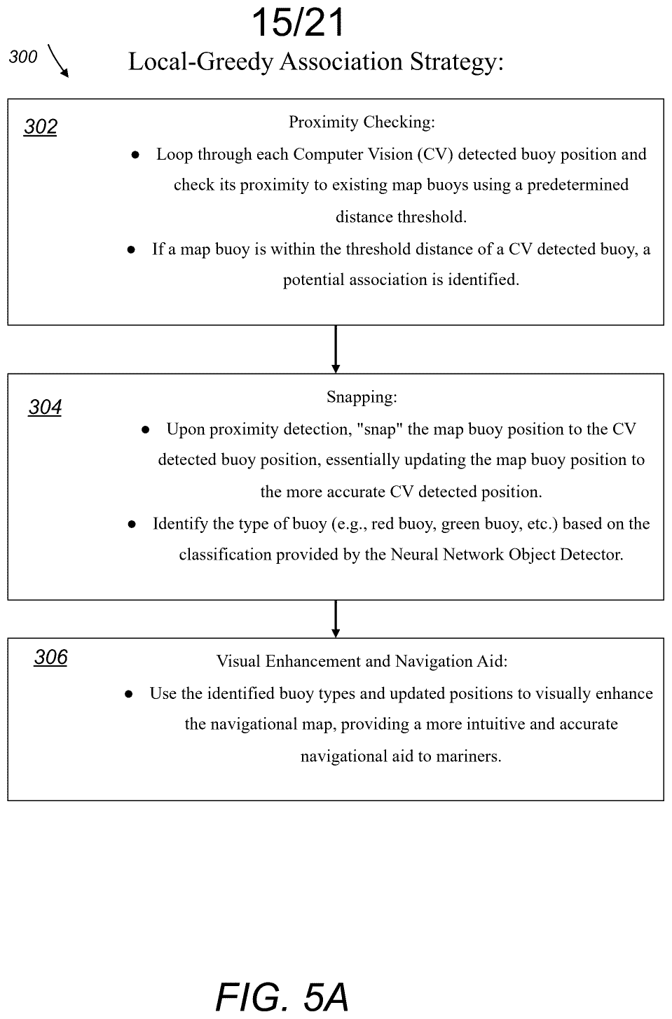

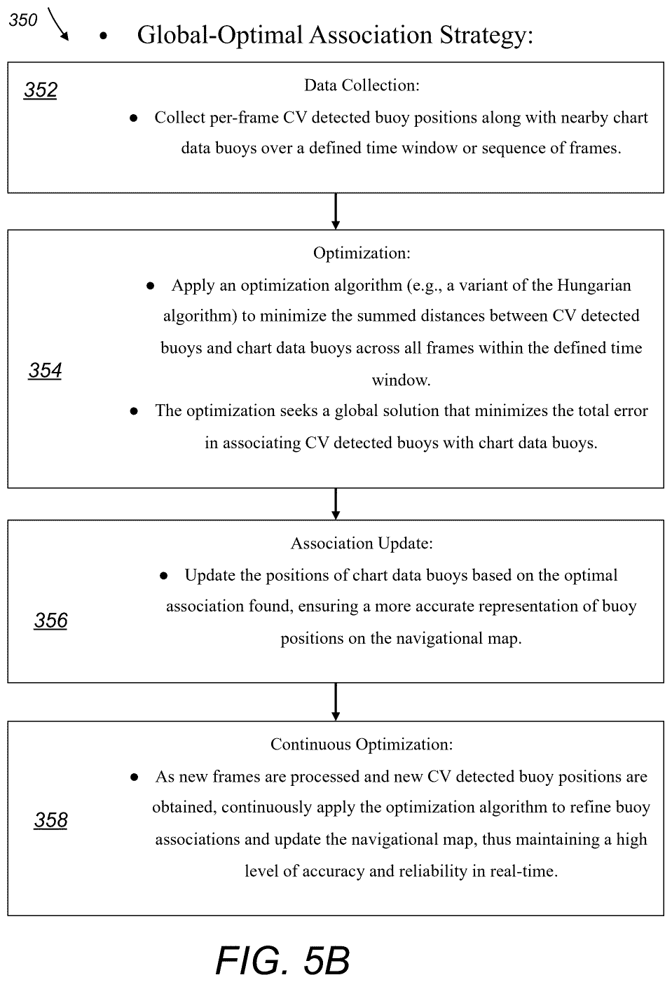

Referring to FIG. 5A, the Local-Greedy Association method 300 includes proximity checking 302, snapping 304, and visual enhancement and navigation aid 306. In each step the following actions are taken:
Local-Greedy Association Strategy (300):
   Proximity Checking (302):
   Loop through each Computer Vision (CV) detected buoy position and check its proximity to existing map buoys using a predetermined distance threshold.
   If a map buoy is within the threshold distance of a CV detected buoy, a potential association is identified.
Snapping (304):
   Upon proximity detection, “snap” the map buoy position to the CV detected buoy position, essentially updating the map buoy position to the more accurate CV detected position.
   Identify the type of buoy (e.g., red buoy, green buoy, etc.) based on the classification provided by the Neural Network Object Detector.
Visual Enhancement and Navigation Aid (306):
   Use the identified buoy types and updated positions to visually enhance the navigational map, providing a more intuitive and accurate navigational aid to mariners.

Referring to FIG. 5B, the Global-Optimal Association method 350 includes data collection 352, optimization 354, association update 356, and continuous optimization 358. In each step the following actions are taken:
Global-Optimal Association Strategy (350):
   Data Collection (352):
      Collect per-frame CV detected buoy positions along with nearby chart data buoys over a defined time window or sequence of frames.
   Optimization (354):
      Apply an optimization algorithm (e.g., a variant of the Hungarian algorithm) to minimize the summed distances between CV detected buoys and chart data buoys across all frames within the defined time window.
      The optimization seeks a global solution that minimizes the total error in associating CV detected buoys with chart data buoys.
   Association Update (356):
      Update the positions of chart data buoys based on the optimal association found, ensuring a more accurate representation of buoy positions on the navigational map.
   Continuous Optimization (358):
      As new frames are processed and new CV detected buoy positions are obtained, continuously apply the optimization algorithm to refine buoy associations and update the navigational map, thus maintaining a high level of accuracy and reliability in real-time.

These strategies enable a robust and accurate alignment of detected buoy positions with existing chart data, significantly enhancing the navigational accuracy and providing mariners with a reliable and visually enriched navigational aid.

### Applications and Advantages

The Automated Navigational Marker Detection and Association System, through its innovative integration of RGB cameras, neural network-based object detection, and real-time mapping technologies, opens up a plethora of applications and advantages in the maritime domain.

### Applications:

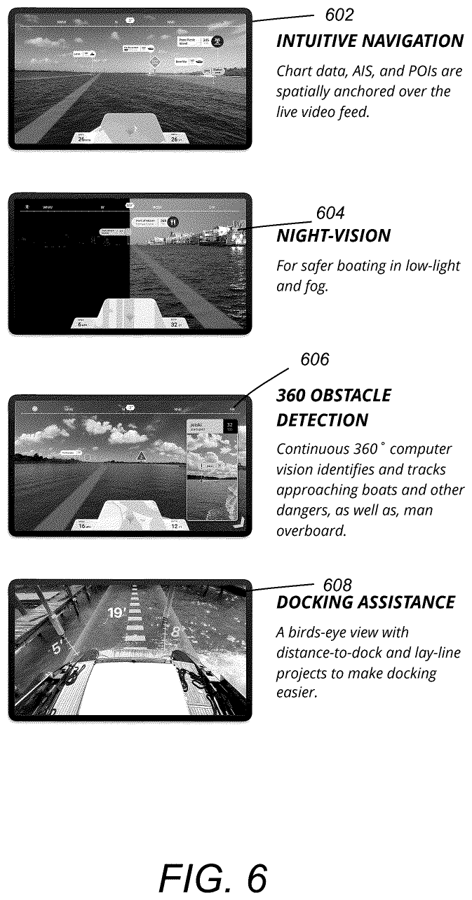

Congested Waterways Navigation 602, shown in FIG. 6:
   The system significantly aids in navigating through congested waterways by accurately identifying and mapping navigational markers in real-time, thus providing clear, updated navigational pathways to mariners. Chart data, AIS and point of interests (POIs) are spatially anchored over live video feed.
360° Obstacle Detection 606, shown in FIG. 6
   Continuous 360° computer vision identifies and tracks approaching boats and other dangers, as well, as man overboard.
   Docking Assistance 608, shown in FIG. 6:
      A birds-eye view image with distance-to-dock and lay-line projects to make docking easier.
   Adverse Weather Conditions:
      In adverse weather conditions where manual detection of navigational markers becomes exceedingly challenging, the system continues to provide reliable detection and association, ensuring safe navigation.
   Night-time Navigation 604, as shown in FIG. 6:
      The ability to detect navigational markers even in low light conditions facilitates safer night-time navigation.
   Search and Rescue Operations:
      During search and rescue operations, accurate mapping of navigational markers can provide critical information and enhance operational efficiency.
   Maritime Surveillance and Security:
      The system can be employed for maritime surveillance, ensuring the correct navigation of vessels and detecting any unauthorized movements or anomalies in waterways.
   Vessel identification:
      The system can be used for vessel identification including boar type, color, and registration number, among others.
   Training and Simulation:
      The system can also be utilized in training simulations to provide realistic, real-time navigational scenarios to trainees.

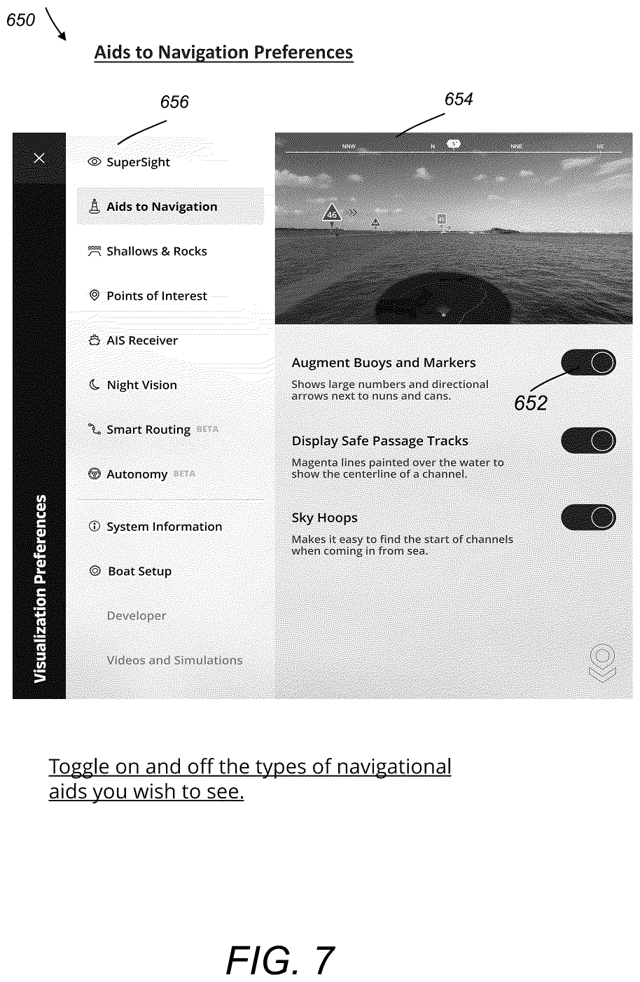

Referring to FIG. 7, a screenshot 650 of the system includes a display 654, menu items 656 and toggles 652 that enable selections of the above mentioned applications and display of the generated navigational maps.

### Autodocking Application

The invention introduces a comprehensive solution for automating maritime docking through a single elevated monocular sensor. It leverages computer vision algorithms for scene segmentation and distance estimation to docks, while also providing auditory feedback to assure operators of system functionality. The system enhances onboard safety by alerting operators to human presence near the vessel's edge or dock.

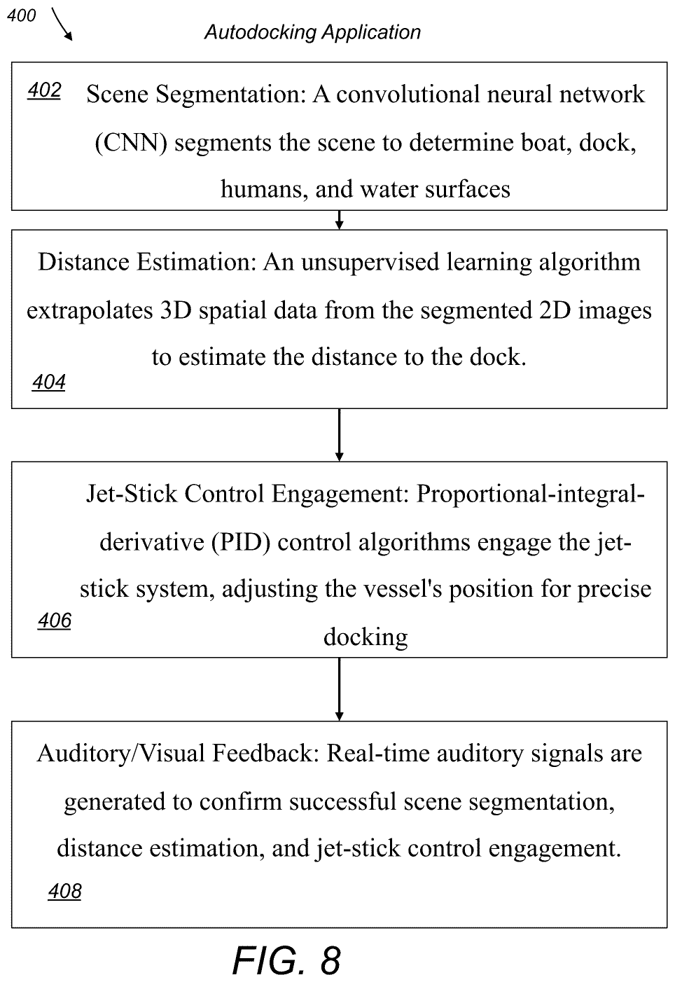

The system of FIG. 1A is used for boat autodocking applications. Referring to FIG. 8, the autodocking application 400 includes scene segmentation 402, distance estimation 404, jet-stick control engagement 406 and auditory/visual feedback 408. The camera system 102 captures real-world visual data and outputs 2D image data which are send to the embedded computing unit 103 for segmentation, distance estimation and human detection. In the scene segmentation step 402 a convolutional neural network (CNN) segments the scene to determine boat, dock, water surfaces, and humans, if any. For human detection, the CNN object classifier scans the segmented image for feature vectors corresponding to human silhouettes. Upon positive identification, an alert is triggered on the operator interface via an API call, and appropriate feedback is generated. Next, in the distance estimation step 404, an unsupervised learning algorithm extrapolates 3D spatial data from the segmented 2D images to estimate the distance to the dock. Next, in the jet-stick control engagement step 406, the processed data from the computing unit are used to generate control signals for vessel's propulsion and steering. In this step, proportional-integral-derivative (PID) control algorithms engage the jet-stick system, adjusting the vessel's position for precise docking. Real-time auditory signals and visual feedback are generated to confirm successful scene segmentation, distance estimation, human detection, and jet-stick control engagement. The operator interface provides the visual and auditory alerts and the auditory feedback system outputs the auditory signals.

### Person-Overboard Detection and Automated Response

The invention provides a system that utilizes a monocular sensor to detect persons near the edge of a maritime vessel and takes automated actions if a person falls overboard. The system highlights the person on a display, marks their last known position, sounds an alarm, and automatically halts the vessel.

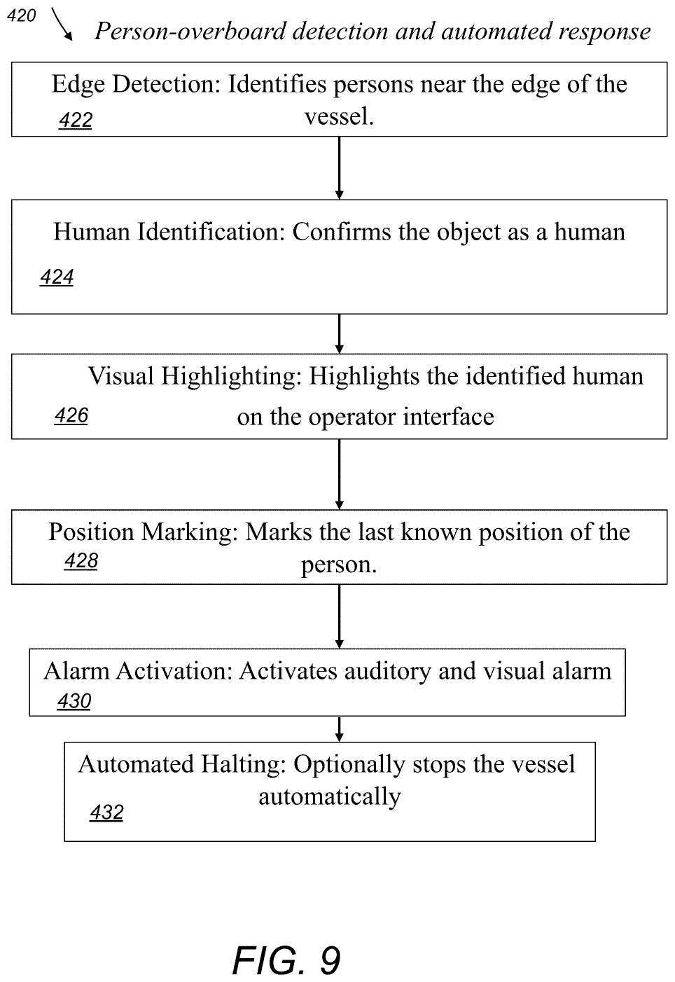

The system of FIG. 1A is used for person-overboard detection and automated response. Referring to FIG. 9, the person-overboard detection and automated response application 420 includes edge detection 422, human identification 424, visual highlighting 426, position marking 428, alarm activation 430, and automated halting 432. In the edge detection step 422, a person near the edge of the vessel is identified. In the human identification step 424, the identified object is confirmed as a human. In the visual highlighting step 426, the identified human is highlighted on the operator interface. In the position marking step 428, the last known position of the identified person is marked. In the alarm activation step 430, auditory and visual alarms are activated. In the automated halting step 432, the vessel is stopped automatically or the direction is changed.

Advantages of the invention include one or more of the following:
Enhanced Maritime Safety: By accurately detecting and associating navigational markers in real-time, the system significantly enhances maritime safety, reducing the likelihood of navigational errors that could lead to accidents.
Improved Navigation Precision: The integration of real-time visual data with existing chart data provides a more accurate and visually enriched navigational map, improving navigation precision.
Reduced Human Error: The system minimizes the dependency on manual observation and interpretation of navigational markers, thereby reducing the potential for human error.
Real-time Updating and Verification: Unlike traditional navigational aids, the system provides real-time updating and verification of navigational marker positions against existing chart data, ensuring the most current and accurate information is available to mariners.
Scalable and Versatile: The system is designed to cater to a broad spectrum of vessels operating in diverse maritime conditions and navigational scenarios, making it a scalable and versatile solution for various maritime applications.
Cost-effective: By leveraging existing technologies like RGB cameras and machine learning algorithms, the system provides a cost-effective solution to enhance maritime navigation significantly.
Ease of Integration: The system can be easily integrated with existing maritime navigation infrastructures, making it a practical solution for immediate implementation and adoption.

Through these applications and advantages, the Automated Navigational Marker Detection and Association System revolutionizes maritime navigation, setting a new standard for safety, accuracy, and operational efficiency in the maritime domain.

The above described system and method are configured to operate on a wide range of vessels including but not limited to commercial vessels, fishing boats, recreational boats, and sailing yachts. The above described system and method enhance maritime safety and navigation precision by providing real-time detection, identification, and association of navigational markers, and integration of this information into a navigational map

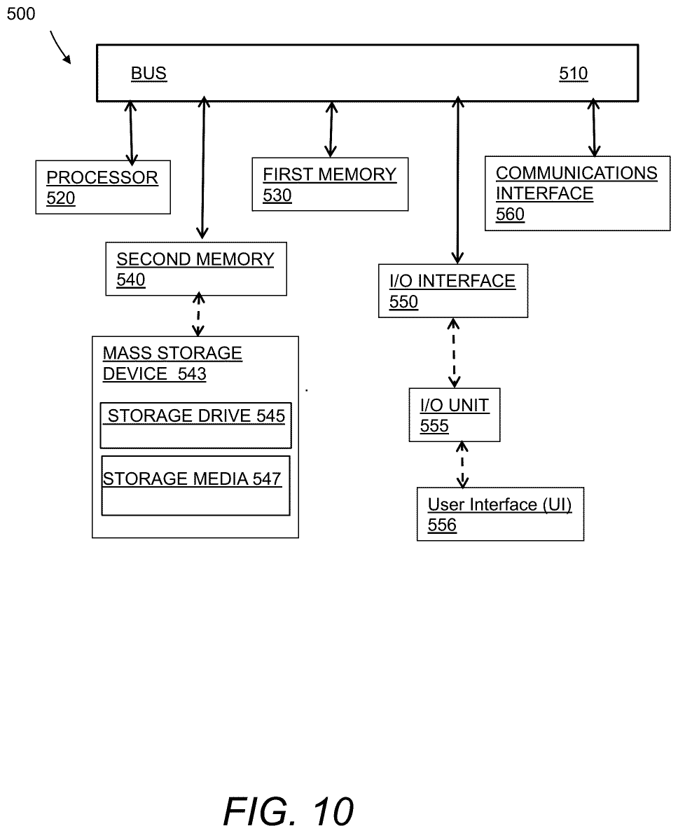

Referring to FIG. 10, an exemplary computer system 500 or network architecture that may be used to implement the system of the present invention includes a processor 520, first memory 530, second memory 540, I/O interface 550 and communications interface 560. All these computer components are connected via a bus 510. One or more processors 520 may be used. Processor 520 may be a special-purpose or a general-purpose processor. As shown in FIG. 7, bus 510 connects the processor 520 to various other components of the computer system 500. Bus 510 may also connect processor 520 to other components (not shown) such as, sensors, and servomechanisms. Bus 510 may also connect the processor 520 to other computer systems. Processor 520 can receive computer code via the bus 510. The term “computer code” includes applications, programs, instructions, signals, and/or data, among others. Processor 520 executes the computer code and may further send the computer code via the bus 510 to other computer systems. One or more computer systems 500 may be used to carry out the computer executable instructions of this invention.

Computer system 500 may further include one or more memories, such as first memory 530 and second memory 540. First memory 530, second memory 540, or a combination thereof function as a computer usable storage medium to store and/or access computer code. The first memory 530 and second memory 540 may be random access memory (RAM), read-only memory (ROM), a mass storage device, or any combination thereof. As shown in FIG. 20, one embodiment of second memory 540 is a mass storage device 543. The mass storage device 543 includes storage drive 545 and storage media 547. Storage media 547 may or may not be removable from the storage drive 545. Mass storage devices 543 with storage media 547 that are removable, otherwise referred to as removable storage media, allow computer code to be transferred to and/or from the computer system 500. Mass storage device 543 may be a Compact Disc Read-Only Memory (“CDROM”), ZIP storage device, tape storage device, magnetic storage device, optical storage device, Micro-Electro-Mechanical Systems (“MEMS”), nanotechnological storage device, floppy storage device, hard disk device, USB drive, among others. Mass storage device 543 may also be program cartridges and cartridge interfaces, removable memory chips (such as an EPROM, or PROM) and associated sockets.

The computer system 500 may further include other means for computer code to be loaded into or removed from the computer system 500, such as the input/output (“I/O”) interface 550 and/or communications interface 560. The computer system 500 may further include a user interface (UI) 556 designed to receive input from a user for specific parameters. Both the I/O interface 550 and the communications interface 560 and the user interface 556 allow computer code and user input to be transferred between the computer system 500 and external devices including other computer systems. This transfer may be bi-directional or omni-direction to or from the computer system 500. Computer code and user input transferred by the I/O interface 550 and the communications interface 560 and the UI 556 are typically in the form of signals, which may be electronic, electromagnetic, optical, or other signals capable of being sent and/or received by the interfaces. These signals may be transmitted via a variety of modes including wire or cable, fiber optics, a phone line, a cellular phone link, infrared (“IR”), and radio frequency (“RF”) link, among others.

The I/O interface 550 may be any connection, wired or wireless, that allows the transfer of computer code. In one example, I/O interface 550 includes an analog or digital audio connection, digital video interface (“DVI”), video graphics adapter (“VGA”), musical instrument digital interface (“MIDI”), parallel connection, PS/2 connection, serial connection, universal serial bus connection (“USB”), IEEE1394 connection, PCMCIA slot and card, among others. In certain embodiments the I/O interface connects to an I/O unit 555 such as a user interface (UI) 556, monitor, speaker, printer, touch screen display, among others. Communications interface 560 may also be used to transfer computer code to computer system 500. Communication interfaces include a modem, network interface (such as an Ethernet card), wired or wireless systems (such as Wi-Fi, Bluetooth, and IR), local area networks, wide area networks, and intranets, among others.

The invention is also directed to computer products, otherwise referred to as computer program products, to provide software that includes computer code to the computer system 500. Processor 520 executes the computer code in order to implement the methods of the present invention. In one example, the methods according to the present invention may be implemented using software that includes the computer code that is loaded into the computer system 500 using a memory 530, 540 such as the mass storage drive 543, or through an I/O interface 550, communications interface 560, user interface UI 556 or any other interface with the computer system 500. The computer code in conjunction with the computer system 500 may perform any one of, or any combination of, the steps of any of the methods presented herein. The methods according to the present invention may be also performed automatically, or may be invoked by some form of manual intervention. The computer system 500, or network architecture, of FIG. 7 is provided only for purposes of illustration, such that the present invention is not limited to this specific embodiment.

Several embodiments of the present invention have been described. Nevertheless, it will be understood that various modifications may be made without departing from the spirit and scope of the invention. Accordingly, other embodiments are within the scope of the following claims.

1. A method for automated navigational marker detection and association in maritime applications, comprising:
providing a camera system equipped with one or more red-green-blue (RGB) cameras for capturing visual data of a surrounding maritime environment in real-time;
providing a computing unit comprising a neural network-based object detector, a projection mechanism module, and a GPS mapping and chart data integration module;
providing a database comprising pre-existing chart data of navigational markers;
capturing visual data of the surrounding maritime environment using the camera system;
processing said visual data by the computing unit using the neural network-based object detector to identify navigational markers;
projecting pixel positions of detected navigational markers into a three-dimensional (3D) coordinate system;
integrating the projected positions of the detected navigational markers into a navigational map; and
cross-referencing the projected positions of the detected navigational markers with pre-existing chart data of navigational markers for the same location to enhance navigational accuracy and reliability.

2. The method of claim 1, wherein the projection mechanism module uses an inertial measurement unit (IMU)-based orientation estimation techniques to facilitate the projection of pixel positions into the 3D coordinate system.

3. The method of claim 1, wherein the projection mechanism module uses a Computer Vision (CV)-based orientation estimation techniques to facilitate the projection of pixel positions into the 3D coordinate system.

4. The method of claim 1, further comprising using a local-greedy association strategy for aligning the detected navigational markers positions with the pre-existing chart data based on proximity.

5. The method of claim 1, further comprising using a global-optimal association strategy that utilizes an optimization algorithm to minimize the summed distances between the detected navigational markers positions and the pre-existing chart data for the navigational markers.

6. The method of claim 1, wherein the neural network-based object detector is trained to identify navigational markers based on characteristic shapes, colors, and patterns.

7. The method of claim 1, wherein the neural network-based object detector provides bounding boxes and confidence scores for each detected navigational marker.

8. The method of claim 7, wherein the neural network-based object detector further classifies the type of the detected navigational marker.

9. The method of claim 1, wherein the GPS mapping and chart data integration module updates a navigational map in real-time to reflect the positions of detected navigational markers, and enhances the visual representation of said navigational map based on the association with the pre-existing chart data.

10. An automated navigational marker detection and association system for maritime applications, comprising:
a camera system equipped with one or more red-green-blue (RGB) cameras for capturing visual data of the surrounding maritime environment in real-time;
a computing unit comprising a neural network-based object detector, a database comprising chart data of navigational markers, a projection mechanism module, and a GPS mapping and chart data integration module;
wherein the neural network-based object detector is configured to process said visual data to identify navigational markers;
wherein the projection mechanism module is configured to project pixel positions of detected navigational markers into a three-dimensional (3D) coordinate system by extending rays from said pixel positions to a water surface thereby generating projected positions of detected navigational markers; and
wherein the GPS mapping and chart data integration module is configured to integrate the projected positions of the detected navigational markers into a navigational map, and to cross-reference and compare said projected positions of the detected navigational markers with pre-existing chart data of navigational markers stored in the database for the same location.

11. The system of claim 10, wherein the projection mechanism uses an Inertial Measurement Unit (IMU)-based orientation estimation techniques to facilitate the projection of pixel positions into the 3D coordinate system.

12. The system of claim 10, wherein the projection mechanism uses a Computer Vision (CV)-based orientation estimation techniques to facilitate the projection of pixel positions into the 3D coordinate system.

13. The system of claim 10, further comprising a local-greedy association strategy for aligning the detected navigational markers positions with pre-existing chart data based on proximity.

14. The system of claim 10, further comprising a global-optimal association strategy that utilizes an optimization algorithm to minimize the summed distances between the detected navigational markers positions and pre-existing chart data for the navigational markers.

15. The system of claim 10, wherein the neural network-based object detector is trained to identify navigational markers based on characteristic shapes, colors, and patterns.

16. The system of claim 10, wherein the neural network-based object detector provides bounding boxes and confidence scores for each detected navigational marker.

17. The system of claim 16, wherein the neural network-based object detector further classifies the type of navigational marker.

18. The system of claim 10, wherein the GPS mapping and chart data integration module updates a navigational map in real-time to reflect the positions of detected navigational markers, and enhances the visual representation of said navigational map based on the association with pre-existing chart data.

19. The system of claim 10, wherein said system is configured to operate on commercial vessels, fishing boats, recreational boats, and sailing yachts.
